(19) United States
(12) Patent Application Publication
(10) Pub. No.: US 2019/0203913 A1
(43) Pub. Date: Jul. 4, 2019

(54) Laser Snowfall Light

(71) Applicant: Dongguan Lanyu Laser Co., Ltd, Guangdong (CN)

(72) Inventor: Yongbing Wu, Anhui (CN)

(21) Appl. No.: 15/869,965

(22) Filed: Jan. 12, 2018

(30) Foreign Application Priority Data
Dec. 28, 2017 (CN) 201721876482.2

(51) Int. Cl. F21V 14/04; F21S 10/00; F21V 7/00; F21V 17/10

(52) U.S. Cl. CPC F21V 14/04; F21S 10/00; F21Y 2115/30; F21V 17/101; F21V 7/0025; F21V 7/0066

(57) ABSTRACT

The utility model discloses a laser snowfall light, which comprises a laser module, a drive motor and a cambered-surface multi-directional reflecting mirror, wherein the drive motor drives the cambered-surface multi-directional reflecting mirror to rotate, and a light beam emitted by the laser module is irradiated on a surface of the cambered-surface multi-directional reflecting mirror. The light beam emitted by the laser module of the scheme is irradiated on the cambered-surface multi-directional reflecting mirror to exhibit the effect of snowflakes flying all over the sky, and then the cambered-surface multi-directional reflecting mirror is rotated by the drive motor to exhibit the effect of snowflakes falling from the sky.

### FIELD OF THE UTILITY MODEL

The utility model relates to a luminaire and particularly to a laser snowfall light.

### BACKGROUND OF THE UTILITY MODEL

Laser lights are generally divided into industrial laser lights and amusement laser lights. The principle of a laser light is that a laser beam is created by using a YAG solid-state laser, a krypton lamp and a Nd:YAG crystal bar, and then visible green light is formed by frequency conversion. A galvanometer deflects at a high speed under the control of a computer, thus forming beautiful characters or graphics.

Laser light has the advantages of bright colors, height brightness, good directivity, a long range, ease of control and the like, and appears to be more magical and dreamlike. When laser light is applied to buildings, parks, squares, theaters and the like, a laser beam can draw attention from people a few kilometers away due to its non-divergence, and therefore also becomes the focus of attention at a laser emitting point. Most of the existing small laser lights have a single graphic and a fixed pattern.

### SUMMARY OF THE UTILITY MODEL

An object of the utility model is to provide a laser snowfall light so as to solve the problems mentioned in the background art.

To achieve the above object, the utility model provides the following technical solution.

A laser snowfall light comprises a laser module, a drive motor and a cambered-surface multi-directional reflecting mirror, wherein the drive motor drives the cambered-surface multi-directional reflecting mirror to rotate, and a light beam emitted by the laser module is irradiated on a surface of the cambered-surface multi-directional reflecting mirror.

In the laser snowfall light according to claim 1, the light beam irradiated on the cambered-surface multi-directional reflecting mirror by the laser module has a diameter of greater than 5 mm.

In the laser snowfall light according to claim 1, the cambered-surface multi-directional reflecting mirror is drum-shaped.

In the laser snowfall light according to claim 1, the surface of the cambered-surface multi-directional reflecting mirror has a plurality of reflecting surfaces.

In the laser snowfall light according to claim 1, several planar reflecting mirrors are evenly adhered to the surface of the cambered-surface multi-directional reflecting mirror.

In the laser snowfall light according to claim 1, a totally reflecting mirror is arranged between the laser module and the cambered-surface multi-directional reflecting mirror.

Compared with the prior art, the utility model has the following characteristics: when the laser snowfall light is working, a light beam emitted by the laser module is irradiated on several planar reflecting mirrors of the cambered-surface multi-directional reflecting mirror of the snowfall light to exhibit the effect of snowflakes flying all over the sky, and then the cambered-surface multi-directional reflecting mirror of the snowfall light is rotated by the drive motor to exhibit the effect of snowflakes falling from the sky.

### BRIEF DESCRIPTION OF THE DRAWINGS

FIG. 1 is a schematic structural view of a laser snowfall light;

FIG. 2 is a side view of a cambered-surface multi-directional reflecting mirror of the snowfall light in the laser snowfall light;

FIG. 3 is a front view of the cambered-surface multi-directional reflecting mirror of the snowfall light in the laser snowfall light;

FIG. 4 shows the planar reflecting mirrors of the cambered surface.

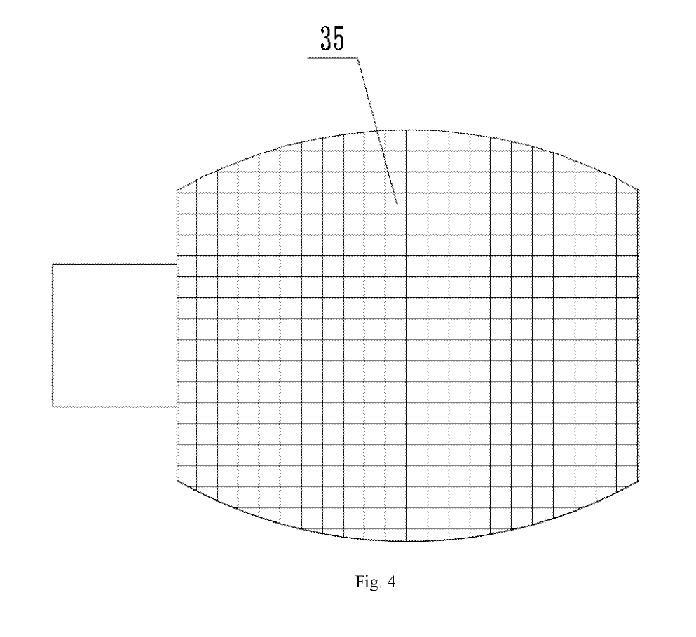

Description of reference numerals: 1. laser module; 2. drive motor; 3. cambered-surface multi-directional reflecting mirror; 35. reflecting mirror; 4. totally reflecting mirror; 5. lens mounting plate; 6. bottom plate.

### DETAILED DESCRIPTION OF THE UTILITY MODEL

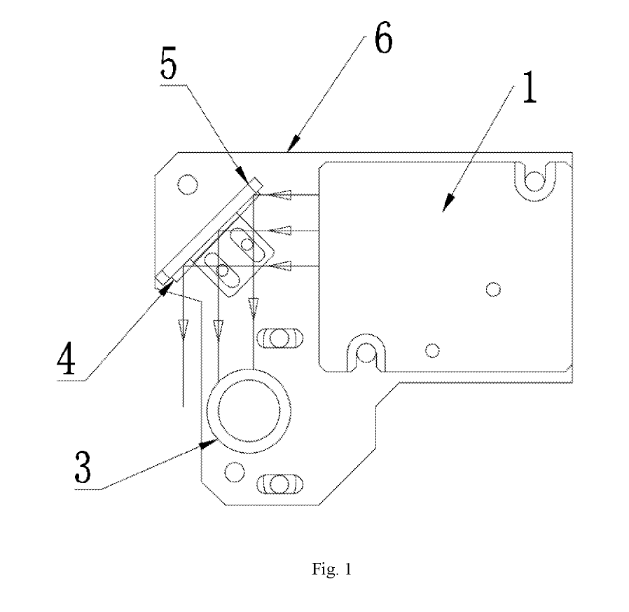

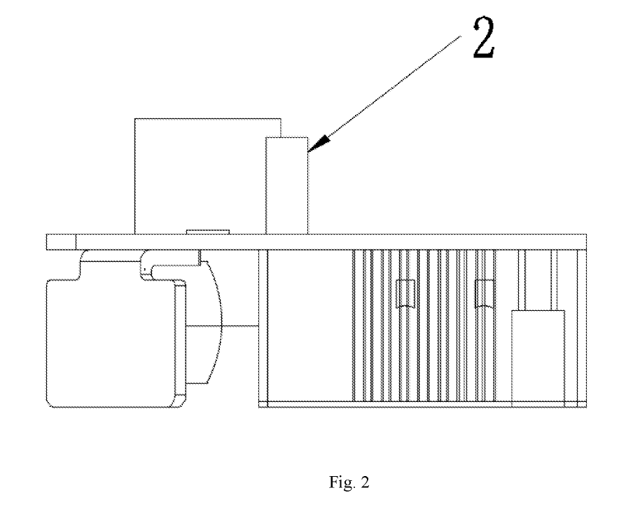

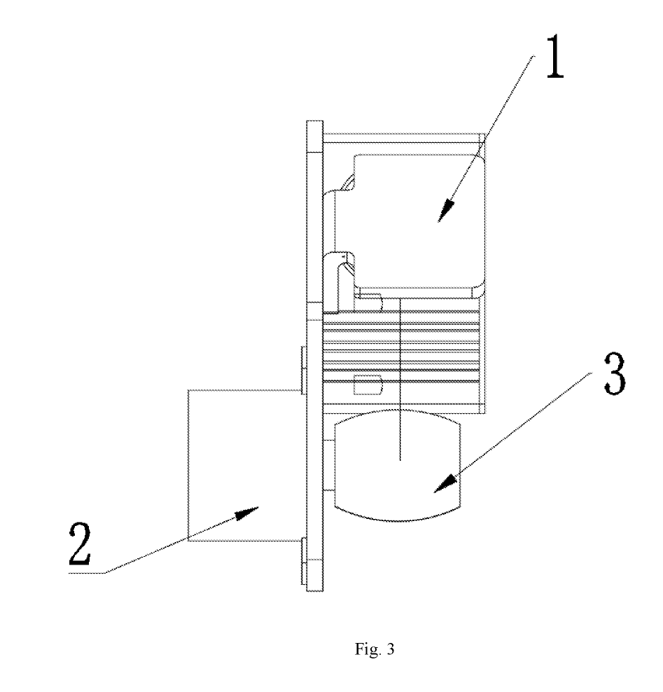

Referring to FIGS. 1-3, the technical solution of the present patent will be further described below in detail with reference to a particular embodiment.

The utility model provides a laser snowfall light, which comprises a laser module 1, a totally reflecting mirror 4, a bottom plate 6, a drive motor 2 and a cambered-surface multi-directional reflecting mirror 3, wherein the laser module 1 is internally fixedly equipped with a laser diode and internally provided with a laser diode mounting slot, and the laser diode is fixedly mounted in the laser diode mounting slot; a totally reflecting lens 4 is fixed to a lens mounting plate 5, the cambered-surface multi-directional reflecting mirror 3 is provided with a drive motor shaft mounting hole, the cambered-surface multi-directional reflecting mirror is drum-shaped, and its cambered surface has several planar reflecting mirrors 35; and the cambered-surface multi-directional reflecting mirror 3 is connected with the drive motor 2 via the mounting hole. When the laser snowfall light of the utility model is working, a light beam emitted by the laser module 1 is irradiated on the cambered-surface multi-directional reflecting mirror 3, the totally reflecting mirror 4 regulates the direction of the light beam irradiated by the laser module 1 to change an irradiation region, the light beam irradiated by the laser module has a diameter of greater than 5 mm (light spot), the cambered-surface multi-directional reflecting mirror exhibits the effect of snowflakes flying all over the sky by light reflection, and then cambered-surface multi-directional reflecting mirror is rotated by the drive motor to exhibit the effect of snowflakes falling from the sky.

A preferred embodiment of the present patent has been described above in detail, but the present patent is not limited to the above embodiment, and those of ordinary skill in the art may also make various changes within their scope of knowledge without departing from the object of the present patent.

1. A laser snowfall light, comprising a laser module, a drive motor and a cambered-surface multi-directional reflecting mirror, wherein the drive motor drives the cambered-surface multi-directional reflecting mirror to rotate, and a light beam emitted by the laser module is irradiated on a surface of the cambered-surface multi-directional reflecting mirror.

2. The laser snowfall light according to claim 1, wherein the light beam irradiated on the cambered-surface multi-directional reflecting mirror by the laser module has a diameter of greater than 5 mm.

3. The laser snowfall light according to claim 1, wherein the cambered-surface multi-directional reflecting mirror is drum-shaped.

4. The laser snowfall light according to claim 1, wherein the surface of the cambered-surface multi-directional reflecting mirror has a plurality of reflecting surfaces.

5. The laser snowfall light according to claim 1, wherein several planar reflecting mirrors are evenly adhered to the surface of the cambered-surface multi-directional reflecting mirror.

6. The laser snowfall light according to claim 1, wherein a totally reflecting mirror is arranged between the laser module and the cambered-surface multi-directional reflecting mirror.
